(19) United States
(12) Patent Application Publication
(10) Pub. No.: US 2025/0347159 A1
(43) Pub. Date: Nov. 13, 2025

(54) LATCH WITH ADJUSTABLE CONTACT POINT FOR BATH

(71) Applicant: Kohler Co., Kohler, WI (US)

(72) Inventor: Andrew Schaub, Port Washington, WI (US)

(73) Assignee: Kohler Co., Kohler, WI (US)

(21) Appl. No.: 19/198,586

(22) Filed: May 5, 2025

Related U.S. Application Data
(60) Provisional application No. 63/644,014, filed on May 8, 2024.

(51) Int. Cl. E05C 3/04; A47K 3/00; E05C 3/00

(52) U.S. Cl. CPC E05C 3/041; A47K 3/006; E05C 3/004

(57) ABSTRACT

A locking assembly includes a latch configured to move between a locked position and an unlocked position and an adjustment assembly including a first component including an engagement feature and a second component including at least a first cutout defining a first depth and a second cutout defining a second depth shallower than the first depth. The first cutout and the second cutout are configured to receive the engagement feature. The first component is movable relative to the second component between a first position and a second position. In the first position, the engagement feature is engaged with the first cutout such that the latch is laterally spaced from the bath by a first distance. In the second position, the engagement feature is engaged with the second cutout such that the latch is laterally spaced from the bath by a second distance greater than the first distance.

### CROSS-REFERENCE TO RELATED PATENT APPLICATIONS

This application claims the benefit of and priority to U.S. Provisional Patent Application No. 63/644,014, filed May 8, 2024, which is incorporated herein by reference in its entirety.

### BACKGROUND

This application generally relates to baths. More specifically, this application relates to walk-in baths that include a door allowing ingress into and egress from the bath and a latch to secure the door in a closed position.

### SUMMARY

One embodiment relates to a locking assembly for a bath including one or more walls and a door repositionable between an open position and a closed position. The locking assembly includes a latch and an adjustment assembly. The latch is coupled to the bath and configured to move between (i) a locked position to retain the door in the closed position and (ii) an unlocked position to permit repositioning the door between the open position and the closed position. The adjustment assembly includes a first component including an engagement feature along a first face of the first component and a second component including a plurality of cutouts along a second face of the second component and including at least a first cutout defining a first depth and a second cutout defining a second depth shallower than the first depth. The first cutout and the second cutout are each configured to receive the engagement feature of the first component. The first component is movable relative to the second component between a first position and a second position. In the first position, the engagement feature of the first component is engaged with the first cutout such that the latch is laterally spaced from the bath by a first distance. In the second position, the engagement feature of the first component is engaged with the second cutout such that the latch is laterally spaced from the bath by a second distance greater than the first distance.

Another embodiment relates to a locking assembly for a bath including one or more walls and a door repositionable between an open position and a closed position. The locking assembly includes a latch and an adjustment assembly. The latch is rotatably coupled to the bath and configured to rotate between (i) a locked position to retain the door in the closed position and (ii) an unlocked position to permit repositioning the door between the open position and the closed position. The adjustment assembly is coupled between the bath and the latch. The adjustment assembly includes a first component including a plurality of engagement features and a second component including a first group of cutouts and a second group of cutouts each configured to receive the plurality of engagement features. Each cutout of the first group of cutouts defines a first depth and each cutout of the second group of cutouts defines a second depth shallower than the first depth. The first component is rotatable relative to the second component between a first position and a second position. In the first position, the plurality of engagement features of the first component are engaged with the first group of cutouts such that the latch is laterally spaced from the bath by a first distance. In the second position, the plurality of engagement features of the first component are engaged with the second group of cutouts such that the latch is laterally spaced from the bath by a second distance greater than the first distance.

Still another embodiment relates to a bath. The bath includes one or more walls defining a bathing volume, a door repositionable between an open position and a closed position to facilitate selective access to the bathing volume, and a locking assembly. The locking assembly includes a latch and an adjustment assembly. The latch is rotatably coupled to a wall of the one or more walls or the door, the latch movable between (i) a locked position to retain the door in the closed position and (ii) an unlocked position to permit repositioning the door between the open position and the closed position. The adjustment assembly is coupled between the bath and the latch. The adjustment assembly includes a first component including an engagement feature and a second component including a plurality of cutouts including at least a first cutout defining a first depth, a second cutout defining a second depth shallower than the first depth, and a third cutout defining a third depth shallower than the second depth. The first cutout, the second cutout, and the third cutout are each configured to receive the engagement feature of the first component. The first component is rotatable relative to the second component between a first position, a second position, and a third position. In the first position, the engagement feature of the first component is engaged with the first cutout such that the latch is laterally spaced from the bath by a first distance. In the second position, the engagement feature of the first component is engaged with the second cutout such that the latch is laterally spaced from the bath by a second distance greater than the first distance. In the third position, the engagement feature of the first component is engaged with the third cutout such that the latch is laterally spaced from the bath by a third distance greater than the second distance.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a bath including a locking assembly in a locked position and a door in a closed position, according to an exemplary embodiment.

FIG. 2 is a perspective view of the bath including the locking assembly of FIG. 1 in an unlocked position and the door in the closed position, according to an exemplary embodiment.

FIG. 3 is a perspective view of the bath including the locking assembly of FIG. 1 in the unlocked position and the door in an open position, according to an exemplary embodiment.

FIG. 4 is an exploded perspective view of the locking assembly of FIG. 1, according to an exemplary embodiment.

FIG. 5 is an exploded perspective view of the locking assembly of FIG. 1, according to an exemplary embodiment.

FIG. 6 is a perspective view of an adjustment plate of the locking assembly of FIG. 1, according to an exemplary embodiment.

FIGS. 7 and 8 are various perspective views of an indexer of the locking assembly of FIG. 1, according to an exemplary embodiment.

FIG. 9 is a perspective view of the adjustment plate of FIG. 6 engaged with the indexer of FIGS. 7 and 8, according to an exemplary embodiment.

FIG. 10 is a perspective view of the adjustment plate of FIG. 6 being transparent to show the engagement with the indexer of FIGS. 7 and 8, according to an exemplary embodiment.

FIG. 11 is a perspective view of the adjustment plate of FIG. 6 engaged with the indexer of FIGS. 7 and 8, according to an exemplary embodiment.

FIG. 12 is a side cross-sectional view of the locking assembly of FIG. 1 spacing a latch from the door by a first distance, according to an exemplary embodiment.

FIG. 13 is a side cross-sectional view of the locking assembly of FIG. 1 spacing the latch from the door by a second distance, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an embodiment, a bath includes one or more walls and a door collectively defining a bathing volume. The door may be repositionable between an open position to facilitate ingress and egress to and from the bathing volume and a closed position to seal the bathing volume to hold a liquid. A locking assembly may be used to retain the door in the closed position. The locking assembly includes a latch configured to rotate relative to the bath between a locked position and an unlocked position. In the unlocked position, the door may freely move between the open and closed position. In the locked configuration, the latch engages with and imparts a force on the bath (e.g., the wall or the door) to retain the door in the closed position. If the latch is positioned farther away from the bath, the force imparted on the bath may be lessened and it may be easier for a user to transition the latch from the unlocked position to the locked position (e.g., when the door is in the closed position).

The locking assembly includes an adjustment assembly configured to adjust a lateral distance that the latch is positioned relative to the bath, and thereby adjust the force imparted on the bath by the latch. The adjustment assembly may include a first component (e.g., an adjustment plate) including one or more engagement features and a second component (e.g., an indexer) including a first cutout and a second cutout. The first and second cutouts may be configured to receive the engagement feature to align (e.g., position, index, etc.) the first component at a first position and a second position, respectively. The first and second cutouts may define different depths. In this manner, when the engagement feature is engaged with the first cutout at the first position, the latch is spaced a first distance from the bath, and when the engagement feature is engaged with the second cutout at the second position, the latch is spaced a second distance from the bath. The second distance may be greater than the first distance such that when the engagement feature is engaged with the second cutout at the second position, the force imparted on the bath by the latch may be lessened and it may be easier for a user to transition the latch from the unlocked position to the locked position.

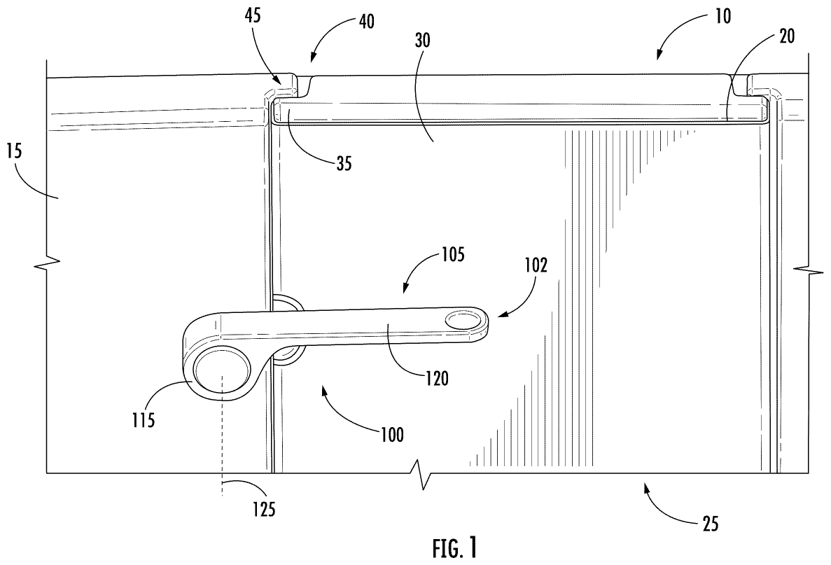

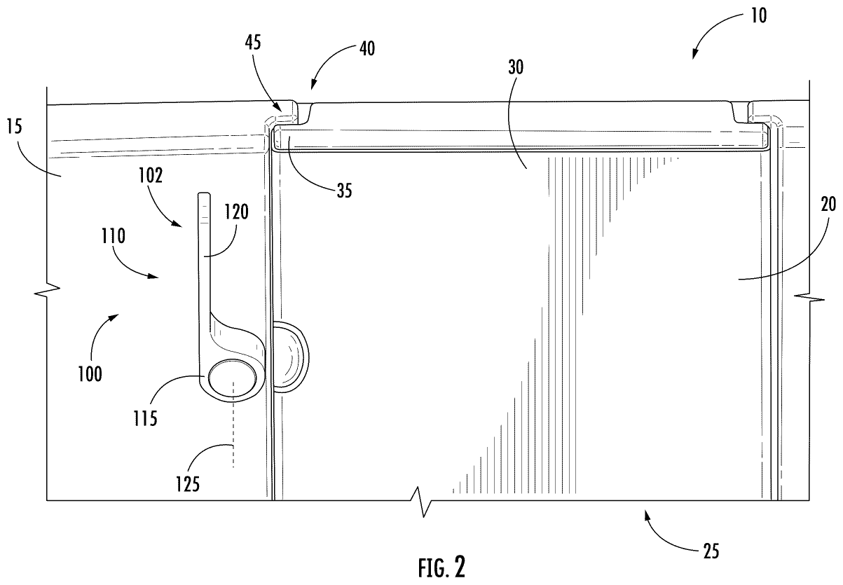

Referring to FIGS. 1-3, a walk-in bath (e.g., a tub, a basin, etc.), shown as bath 10, is configured to facilitate bathing therein. The bath 10 includes one or more walls 15 and a door 20 that collectively define an interior volume, shown as bathing volume 25, of the bath 10. The door 20 is repositionable (e.g., pivotable, rotatable, movable, etc.) between a closed position (as shown in FIGS. 1 and 2) and an open position (as shown in FIG. 3) to facilitate selective access to the bathing volume 25. In the closed position, the door 20 may engage with one or more of the walls 15 to form a seal (e.g., a water-tight seal) therebetween, which seals the bathing volume 25 for holding a fluid (e.g., water, fluid medium, etc.) therein. In the open position, a space (e.g., an opening in one or more of the walls 15 configured to receive the door 20) is provided for a user to ingress into and/or egress from the bathing volume 25.

As shown in FIGS. 1 and 2, the door 20 includes a base portion 30 and a flange 35 extending outward from the base portion 30. The flange 35 may extend outward from the base portion 30 along a handle side 40 of the door 20, a hinge side of the door 20 (e.g., the hinge side opposite the handle side 40), and a bottom side of the door 20. The flange 35 may engage with or otherwise be received by a pocket 45 of the wall 15 to form a seal between the door 20 and the wall 15 when the door 20 is in the closed position (e.g., an exterior facing surface of the flange 35 may engage with an interior facing surface of the pocket 45). The engagement between the flange 35 and the pocket 45 may inhibit rotation of the door 20 in a direction beyond the wall 15. In other words, the pocket 45 acts as a travel stop to the flange 35 and limits rotation of the door 20 such that the door 20 is repositioned in a direction towards the bathing volume 25 to transition the door 20 from the closed position to the open position (e.g., the door 20 opens interior to the bath 10). In this manner, when the bathing volume 25 is filled with liquid, the liquid exerts a force on the door 20 (e.g., a surface of the door 20 facing the bathing volume 25) such that the flange 35 and the pocket 45 engage with each other to form a seal between the door 20 and the wall 15 to inhibit liquid from flowing out of the bathing volume 25. In some embodiments, the door 20 is an outward opening door configured to be repositionable in a direction away from the bathing volume 25 to transition the door 20 from the closed position to the open position (e.g., the door 20 opens exterior to the bath 10). In such embodiments, the pocket 45 acts as a travel stop to the flange 35 and limits rotation of the door 20 beyond the wall 15 (e.g., in a direction towards the bathing volume 25).

As shown in FIGS. 1-5, the bath 10 includes an adjustable lock assembly (e.g., a latch assembly, a retainer assembly, etc.), shown as locking assembly 100, configured to retain the door 20 in the closed position and adjust an applied locking force to retain the door 20. The locking assembly 100 includes a latch (e.g., handle, locking mechanism, etc.), shown as latch 102, and an adjustment assembly (e.g., locking force adjustment assembly, contact point adjustment assembly, etc.), shown as adjustment assembly 200. The latch 102 is configured to rotate relative to the walls 15 and the door 20 between a locked position 105 (as shown in FIG. 1) and an unlocked position 110 (as shown in FIGS. 2 and 3) to selectively lock the door 20 in the closed position. The latch 102 is configured to rotate from the locked position 105 to the unlocked position 110 in a counterclockwise direction, however, it should be understood that the latch 102 may additionally or alternatively rotate from the locked position 105 to the unlocked position 110 in a clockwise direction. As shown in FIGS. 2 and 3, when the latch 102 is in the unlocked position 110, the door 20 is free to reposition between the open position and the closed position. As shown in FIG. 1, when the latch 102 is in the locked position 105 and the door 20 is in the closed position, the door 20 is retained in the closed position by the latch 102. Generally, the latch 102 is rotatably coupled to the bath 10 and configured to engage with a portion of the bath 10 to retain the door 20 in the closed position. In some embodiments, the latch 102 is rotatably coupled to the wall 15 (e.g., a surface of the wall 15 facing the bathing volume 25) and configured to engage with the door 20 to retain the door 20 in the closed position. In other embodiments, the latch 102 is rotatably coupled to the door 20 (e.g., a surface of the door 20 facing the bathing volume 25) and configured to engage with the wall 15 to retain the door 20 in the closed position. In other embodiments, the latch 102 is otherwise suitably positioned to retain the door 20 in the closed position. In some embodiments, the latch 102 is slidable relative to the bath 10 between the locked position 105 and the unlocked position 110 to selectively retain the door 20 in the closed position.

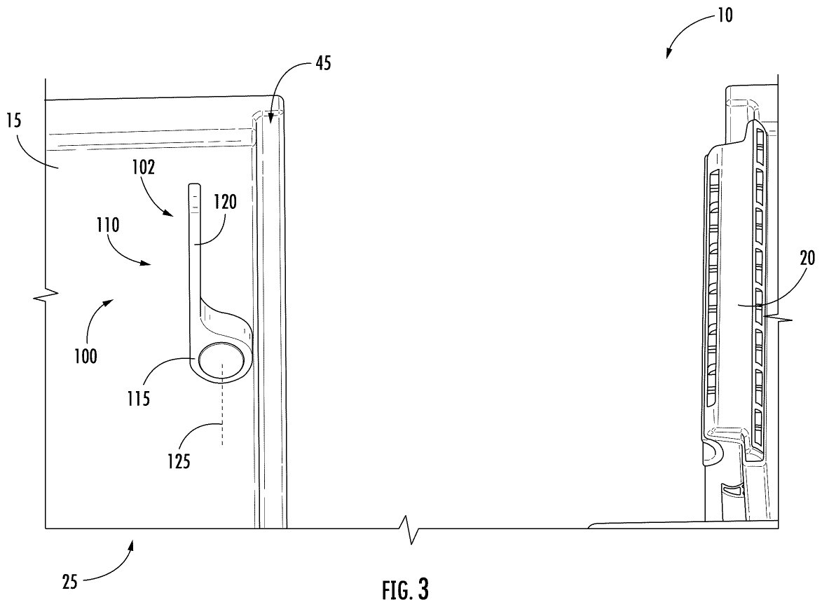

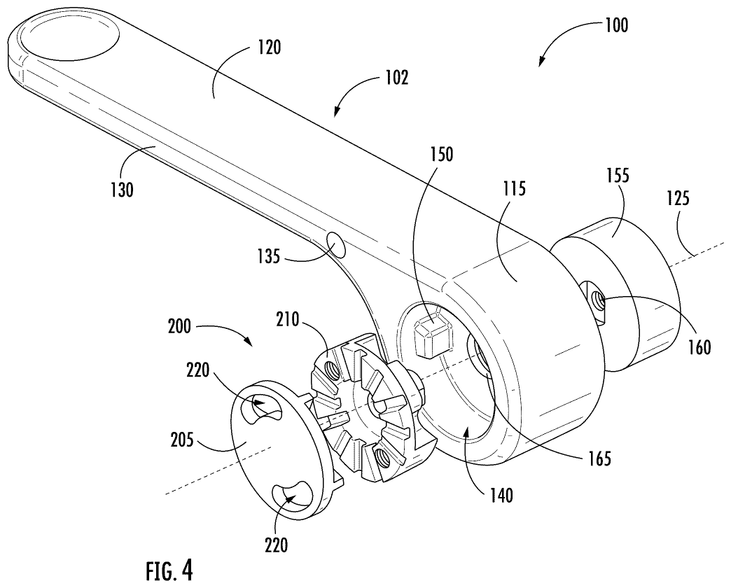

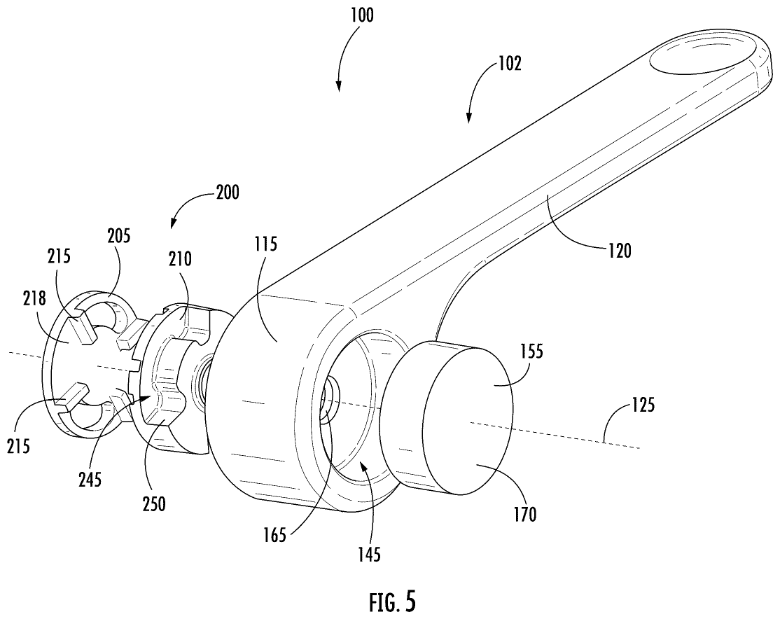

As shown in FIGS. 4 and 5, the latch 102 includes a body 115 and an arm 120 extending from the body 115. The body 115 and the arm 120 may be integrally formed together as a single unitary body. The body 115 may define an axis of rotation, shown as axis 125, about which the latch 102 (e.g., the body 115 and the arm 120) is configured to rotate. The arm 120 may be grasped (e.g., held, contacted, engaged, etc.) by a user to rotate the latch 102 and transition between the locked position 105 and the unlocked position 110.

In the locked position 105, the latch 102 may engage with a portion of the wall 15 and/or door 20 in the closed position to retain the door 20 in the closed position. As shown in

FIG. 4, the arm 120 includes an engagement surface 130 that faces the interior surface of the wall 15 and the interior surface of the door 20. The arm 120 includes a projection 135 (e.g., protrusion, engagement feature, bump, etc.) that extends from the engagement surface 130 in a direction towards the wall 15 and the door 20. The projection 135 may be configured to engage (e.g., contact) a portion of the wall 15 and/or door 20. By way of example, the projection 135 may engage the door 20 when the door 20 is in the closed position and the latch 102 is in the locked position 105. In some embodiments, the projection 135 is structured to bias the door 20 in a direction away from the arm 120 (e.g., in a direction towards the wall 15, in a direction away from the bathing volume 25, etc.) to remove clearances between the door 20 and the wall 15 (e.g., between the flange 35 and the pocket 45). In such embodiments, the projection 135 biases the door 20 in a direction towards the wall 15 upon rotation of the latch 102 to the locked position 105 (e.g., when the door 20 is in the closed position) to provide a water-tight seal between the door 20 and the wall 15. The projection 135 may be semi-spherical or another suitable structure that removes clearances. The projection 135 may be relatively rigid or relatively compressible to provide a locking force (e.g., on the wall 15, on the door 20, etc.) that retains the latch 102 in the locked position 105 when the projection 135 is engaged with the wall 15 and/or door 20. The point at which the projection 135 engages with the wall 15 and/or the door 20 may be referred to hereinafter as a contact point.

As shown in FIGS. 4 and 5, the body 115 includes a first internal portion or cutout, shown as first cavity 140 and a second internal portion or cutout, shown as second cavity 145 along a surface of the body 115 opposite the first cavity 140. The first cavity 140 and the second cavity 145 may define generally circular or spherical shapes. The first cavity 140 and the second cavity 145 may be coaxial with each other and with the axis 125.

The first cavity 140 is configured to receive at least a portion of the adjustment assembly 200 (e.g., at least a portion of the indexer 210). The first cavity 140 may define a shape complementary to the shape of the adjustment assembly 200 and the components included therein. The first cavity 140 may be dimensioned to be larger than the adjustment assembly 200 such that the adjustment assembly 200 can be inserted into and received by the first cavity 140. The body 115 (e.g., the latch 102) is configured to rotate relative to the adjustment assembly 200 as the latch 102 transitions between the locked position 105 and the unlocked position 110. By way of example, the adjustment assembly 200 may be coupled with the bath 10 (e.g., the wall 15, the door 20, etc.) and the latch 102 may rotate relative thereto. In such an example, the adjustment assembly 200 may remain at a fixed location and at least partially received within the first cavity 140 as the latch 102 rotates.

The body 115 includes a protrusion 150 positioned within the first cavity 140. The protrusion 150 is positioned along a radial surface of the body 115 defining the first cavity 140 (e.g., the protrusion 150 is radially offset or spaced from the axis 125) and extends radially inward in a direction towards a center point of the first cavity 140 (e.g., radially inward in a direction toward the axis 125). The protrusion 150 is configured to engage with a portion of the adjustment assembly 200 (e.g., a component, the indexer 210, etc.) to limit rotation of the latch 102. By way of example, the protrusion 150 may engage with the adjustment assembly 200 to limit rotation of the latch 102 in both a first or locking direction and a second or unlocking direction opposite to the first or locking direction. In some embodiments, the body 115 includes two or more protrusions 150 radially spaced from each other (e.g., generally opposite each other) along the surface of the body 115 defining the first cavity 140 and configured to cooperate to limit rotation of the latch 102 in both the first or locking direction and the second of unlocking direction.

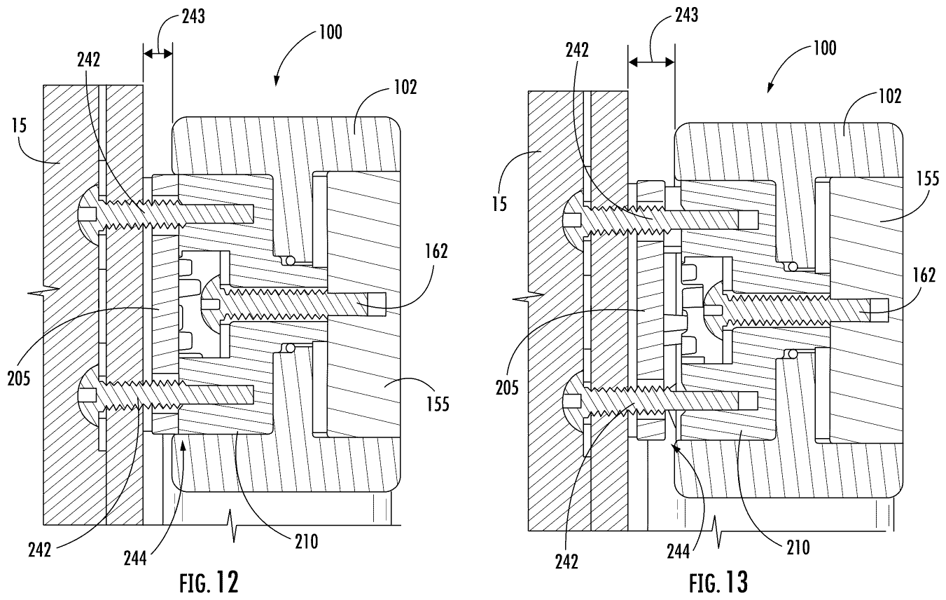

The second cavity 145 is configured to receive at least a portion of an end cap 155. The end cap 155 may be cylindrically shaped or otherwise shaped. The second cavity 145 may define a shape complementary to the shape of the end cap 155. The second cavity 145 may be dimensioned to be larger than the end cap 155 such that the end cap 155 can be inserted into and received by the second cavity 145. The end cap 155 may define an aperture 160 configured to receive a fastener 162 (e.g., bolt, screw, nail, pin, anchor, rivet, etc.) to facilitate coupling the adjustment assembly 200 with the latch 102. In some embodiments, as shown in FIGS. 12 and 13, the aperture 160 includes threads configured to engage with threads of a threaded fastener 162 (e.g., bolt, screw, etc.). By way of example, the fastener 162 may extend along the axis 125 through (i) the adjustment assembly 200, (ii) an aperture 165 of the body 115, and (iii) the aperture 160 (e.g., when the end cap 155 is received within the second cavity 145) to couple the adjustment assembly 200 with the latch 102. In other examples, the adjustment assembly 200, the end cap 155, and the latch 102 are otherwise coupled together. In some embodiments, the end cap 155 does not include the aperture 160 or the adjustment assembly 200 does not include the end cap 155 altogether. In such embodiments, the fastener 162 (e.g., a shoulder bolt, screw, nail, pin, anchor, rivet, etc.) may extend along the axis 125 through (i) the adjustment assembly 200 and (ii) an aperture 165 of the body 115 to couple the adjustment assembly 200 with the latch 102.

The latch 102 may be rotatable relative to the adjustment assembly 200 and the end cap 155. In such an example, the adjustment assembly 200 and the end cap 155 may remain at fixed locations and at least partially received within the first cavity 140 and the second cavity 145, respectively, as the latch 102 rotates. A surface of the end cap 155, shown as exposed surface 170, facing the bathing volume 25 may be substantially flush with the body 115 of the latch 102 when the end cap 155 is fully received within the second cavity 145 and the adjustment assembly 200 is coupled with the latch 102.

As shown in FIGS. 4 and 5, the locking assembly 100 includes the adjustment assembly 200 configured to selectively adjust (e.g., change, vary, etc.) (i) the locking force imparted on the wall 15 and/or the door 20 and (ii) a lateral position of the latch 102 relative to the wall 15 and/or the door 20. By way of example, the adjustment assembly 200 can adjust a lateral distance (e.g., a distance in a direction parallel to the axis 125) between the latch 102 and the wall 15 and/or the door 20, thereby adjusting the locking force imparted by the projection 135 at the contact point on the wall 15 and/or the door 20. The locking force may correspond with a closing force applied to the arm 120 needed to rotate the latch 102 to the locked position 105 to retain the door 20 in the closed position. In some embodiments, a decreased distance between the latch 102 and the wall 15 and/or the door 20 corresponds with a greater locking force imparted on the wall 15 and/or the door 20, and consequently a greater closing force needed to be applied to the arm 120 to rotate the latch 102. The greater the closing force, the more difficult it may be for a user to transition the latch 102 from the unlocked position 110 to the locked position 105 to retain the door 20 in the closed position. Accordingly, the adjustment assembly 200 facilitates adjusting the distance between the latch 102 and the wall 15 and/or the door 20 if it is too difficult for a user to rotate the latch 102. Similarly, the adjustment assembly 200 can be adjusted to increase the locking force to ensure a water-tight seal between the wall 15 and the door 20. In one embodiment, a set screw is used to adjust and hold the projection 135 and its position relative to the engagement surface 130.

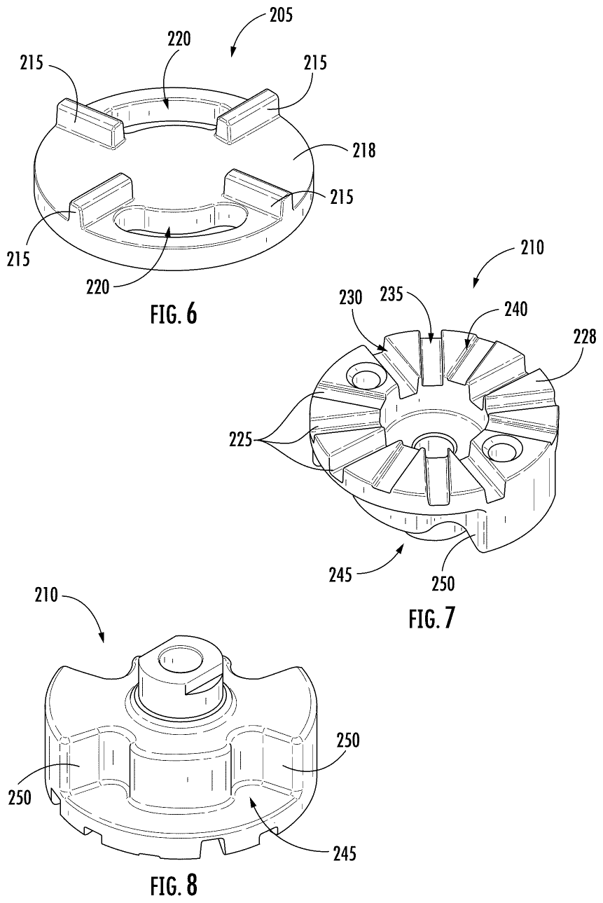

As shown in FIGS. 4-8, the adjustment assembly 200 includes a first component, shown as adjustment plate 205, and a second component, shown as indexer 210. As best shown in FIG. 6, the adjustment plate 205 includes a plurality of protrusions (e.g., extensions, raised features, etc.), shown as engagement features 215, extending from and positioned along a face, shown as surface 218, of the adjustment plate 205 facing the latch 102 (e.g., when the adjustment assembly 200 is coupled with the latch 102). Each engagement feature 215 defines a height (e.g., a distance of extension from the adjustment plate 205) that is substantially equal to the height of each other engagement feature 215. The engagement features 215 may define a generally rectangular, elongated shape. In some embodiments, the engagement features 215 are otherwise shaped.

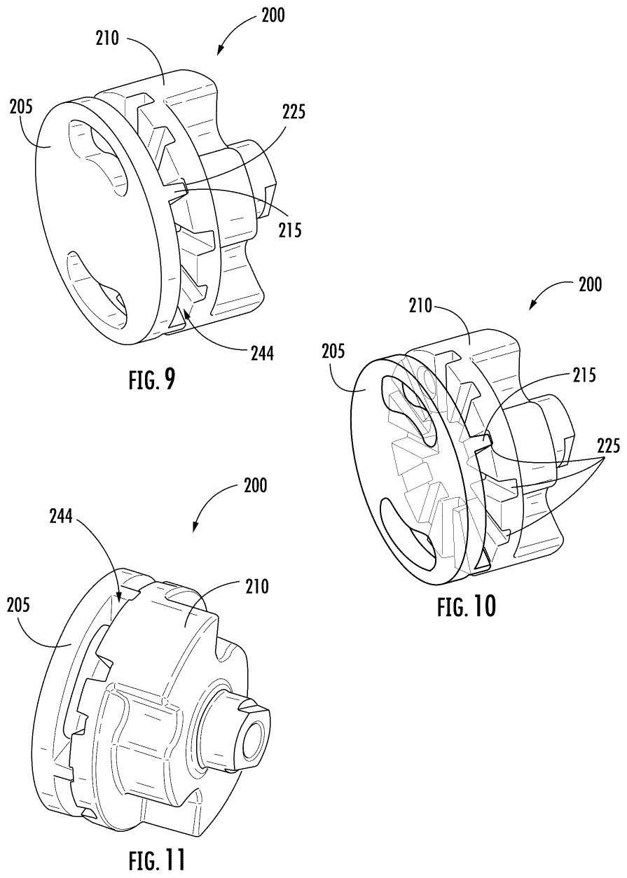

As shown in FIGS. 5, 6, and 9-11, the engagement features 215 are radially spaced and annularly spaced apart from each other in a generally circular array (e.g., pattern). In some embodiments, the engagement features 215 are not radially spaced apart, and instead, extend from a first point along an outer circumference of the adjustment plate 205 to an opposite second point along the outer circumference (e.g., passing through a center point of the adjustment plate 205). In some embodiments, the engagement features 215 are equally annularly spaced apart along the outer circumference of the adjustment plate 205. In other embodiments, the engagement features 215 are otherwise spaced about the adjustment plate 205. In some embodiments, the adjustment plate 205 includes four engagement features 215. By way of example, the adjustment plate 205 may include a first engagement feature 215, a second engagement feature 215 opposite the first engagement feature 215, a third engagement feature 215 positioned annularly between (e.g., equally spaced between) the first engagement feature 215 and the second engagement feature 215, and a fourth engagement feature 215 opposite the third engagement feature 215 and positioned annularly between (e.g., equally spaced between) the first engagement feature 215 and the second engagement feature 215. In other embodiments, the adjustment plate 205 includes more or fewer than four engagement features 215.

The adjustment plate 205 may include one or more apertures 220 extending therethrough. The apertures 220 may be configured to receive a fastener to facilitate selectively rotatably coupling the adjustment plate 205 to the indexer 210. The apertures 220 may be curved so as to follow (e.g., match) the curvature of the outer circumference of the adjustment plate 205. The apertures 220 are structured to enable rotation of the adjustment plate 205 relative to the indexer 210 while the fasteners (i) couple the adjustment plate 205 to the indexer 210 and (ii) remain received within the apertures 220. By way of example, the fasteners may be tightened to inhibit rotation of the adjustment plate 205 relative to the indexer 210 and loosened to permit rotation of the adjustment plate 205 relative to the indexer 210.

As shown in FIGS. 4 and 7-11, the indexer 210 includes a plurality of channels (e.g., pockets, slots, recesses, grooves, etc.), shown as cutouts 225, positioned along a face, shown as surface 228, of the indexer 210 and configured to receive at least a portion of the engagement features 215. The cutouts 225 may define a shape complementary to the shape of the engagement features 215 to facilitate reception of at least a portion thereof. The cutouts 225 may be radially spaced and annularly spaced apart from each other in a pattern complementary to the pattern (e.g., the circular array) of the engagement features 215. The cutouts 225 may define a depth (e.g., a distance of the cutout 225 in a direction parallel to the axis 125).

The indexer 210 may include a plurality of groups (e.g., arrays) of cutouts 225. Each group of cutouts 225 includes a number of cutouts 225 complementary (e.g., equal) to the number of engagement features 215 of the adjustment plate 205. In some embodiments, the cutouts 225 included in a particular group of cutouts 225 each define a substantially similar depth (e.g., a common depth). In such embodiments, the depths of the cutouts 225 of a first group may be different than the depths of the cutouts 225 of a second group. By way of example, as shown in FIG. 7, the indexer 210 may include a first group of cutouts 230 each having a first depth (e.g., each cutout 225 of the first group of cutouts 230 define the first depth), a second group of cutouts 235 each having a second depth (e.g., each cutout 225 of the second group of cutouts 235 define the second depth), and a third group of cutouts 240 each having a third depth (e.g., each cutout 225 of the third group of cutouts 240 define the third depth). The first depth may be greater than each of the second depth and the third depth, and the second depth may be greater than the third depth. In this manner, the cutouts 225 of the first group of cutouts 230 are deeper than those of each of the second group of cutouts 235 and the third group of cutouts 240, and the cutouts 225 of the third group of cutouts 240 are shallower than those of each of the second group of cutouts 235 and the first group of cutouts 240. In some embodiments, the indexer 210 includes more or fewer than three groups of cutouts 240

As shown in FIGS. 9-13, each group of cutouts 225 (e.g., the first group of cutouts 230, the second group of cutouts 235, the third group of cutouts 240, etc.) can receive at least a portion of the engagement features 215 to align the adjustment plate 205 to a predefined position (e.g., the groups of cutouts 225 of the indexer 210 facilitate indexing the adjustment plate 205 to a predefined indexed position). By way of example, the adjustment plate 205 and the indexer 210 may be rotated relative to each other to engage the engagement features 215 with any one of the groups of cutouts 225 of the indexer 210 (e.g., to facilitate reception of the engagement features 215 into any one of the groups of cutouts 225), thereby aligning or indexing the adjustment plate 205 at the predefined position associated with each group of cutouts 225.

The adjustment plate 205 and the indexer 210 may be coupled together (e.g., by way of one or more fasteners 242, shown in FIGS. 12 and 13 extending through the apertures 220 and one or more apertures of the indexer 210) to selectively prevent the adjustment plate 205 from rotating relative to the indexer 210, thereby retaining the engagement, alignment, or index of the engagement features 215 with the group of cutouts 225. The adjustment plate 205 may be rotatable relative to the indexer 210 (e.g., responsive to loosening or removing of the fasteners 242) to facilitate engaging, aligning, or otherwise indexing the engagement features 215 with a different group of cutouts 225 (e.g., an adjacent group of cutouts 225). By way of example, the adjustment plate 205 may rotate relative to the indexer 210 to index the engagement features 215 at a first position associated with the first group of cutouts 230, a second position associated with the second group of cutouts 235, or a third position associated with the third group of cutouts 240. The fasteners 242 may facilitate rotatably coupling the locking assembly 100 to the wall 15 and/or door 20.

As shown in FIGS. 9-13, the varying depths of the cutouts 225 between the groups of cutouts 225 facilitate adjusting (i) a lateral position, shown as distance 243, of the latch 102 relative to the wall 15 and/or the door 20 and (ii) a lateral position, shown as space 244, between the adjustment plate 205 and the indexer 210. By way of example, when the adjustment plate 205 and engagement features 215 are indexed (i) at the first position associated with the first group of cutouts 230, the latch 102 may be spaced a first lateral distance 243 from the wall 15 and/or the door 20, (ii) at the second position associated with the second group of cutouts 235, the latch 102 may be spaced a second lateral distance 243 from the wall 15 and/or the door 20, and (iii) at the third position associated with the third group of cutouts 240, the latch 102 may be spaced a third lateral distance 243 from the wall 15 and/or the door 20. In such an example, due to the depths of the cutouts 225 of each of the first group of cutouts 230, the second group of cutouts 235, and the third group of cutouts 240, the first lateral distance 243 is less than the second and third lateral distances 243, and the third lateral distance 243 is greater than the first and second lateral distances 243. By way of example, the distance 243 between the latch 102 and the wall 15 and/or door 20 shown in FIG. 12 is less than the distance 243 between the latch 102 and the wall 15 and/or door 20 shown in FIG. 13. Accordingly, changing the indexed position of the adjustment plate 205 facilitates changing the lateral position of the latch 102 relative to the wall 15 and/or the door 20 and the locking force imparted on the wall 15 and/or the door 20. Similarly, the space 244 between the surface 218 of the adjustment plate 205 and the indexer 210 as shown in FIG. 12 is less than the space 244 between the surface 218 of the adjustment plate 205 and the indexer 210 as shown in FIG. 13.

In some embodiments, when the engagement features 215 are engaged with the cutouts 225 of the first group of cutouts 230, the distance 243 between the latch 102 and the wall 15 and/or door 20 is the smallest (e.g., tightest clearance between the latch 102 and the wall 15 and/or door 20, the space 244 between the surface 218 of the adjustment plate 205 and the surface 228 of the indexer 210 is the smallest, etc.) among each of the first group of cutouts 230, the second group of cutouts 235, and the third group of cutouts 240 and locking force imparted on the wall 15 and/or the door 20 is the greatest. In some embodiments, as shown in FIG. 12, when the engagement features 215 are engaged with the cutouts 225 of the first group of cutouts 230, the surface 218 of the adjustment plate 205 contacts the surface 228 of the indexer 210.

Similarly, in some embodiments, when the engagement features 215 are engaged with the cutouts 225 of the third group of cutouts 240, the distance 243 between the latch 102 and the wall 15 and/or door 20 is the greatest (e.g., largest clearance between the latch 102 and the wall 15 and/or door 20, the space 244 between the surface 218 of the adjustment plate 205 and the surface 228 of the indexer 210 is the greatest, etc.) among each of the first group of cutouts 230, the second group of cutouts 235, and the third group of cutouts 240 and locking force imparted on the wall 15 and/or the door 20 is the smallest.

As shown in FIGS. 5 and 7-11, the indexer 210 includes one or more pathways (e.g., cutouts, recesses, etc.), shown as channel 245. The channel 245 may be defined by one or more shoulders 250 that act as travel stops. The channel 245 may be positioned along a surface of the indexer 210 facing the latch 102 and received within the first cavity 140. The channel 245 may be arced so as to follow the curvature of an outer circumference of the indexer 210. The channel 245 may be configured to receive at least a portion of the protrusion 150 and permit movement of the protrusion 150 within the channel 245. By way of example, as the latch 102 rotates between the locked position 105 and the unlocked position 110, the protrusion 150 translates within the channel 245. The shoulders 250 may be configured to engage with the protrusion 150 to limit rotation of the latch 102. By way of example, the shoulders 250 may engage with the protrusion 150 to limit rotation of the latch 102 in both the first or locking direction and the second or unlocking direction opposite to the first or locking direction.

In an alternative embodiment, the first cavity 140 includes a pathway (e.g., a channel such as channel 245) and the indexer 210 includes a protrusion (e.g., such as protrusion 150). In such embodiments, the channel of the first cavity 140 may be configured to receive at least a portion of the protrusion of the indexer 210 and permit movement of the protrusion within the channel. By way of example, as the latch 102 rotates between the locked position 105 and the unlocked position 110, the protrusion of the indexer 210 may translate within the channel of the first cavity 140. Further, In such embodiments, the channel of the first cavity 140 includes shoulders configured to engage with the protrusion of the indexer 210 to limit rotation of the latch 102 in both the first or locking direction and the second or unlocking direction opposite to the first or locking direction.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the locking assembly 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A locking assembly for a bath including one or more walls and a door repositionable between an open position and a closed position, the locking assembly comprising:
a latch coupled to the bath and configured to move between (i) a locked position to retain the door in the closed position and (ii) an unlocked position to permit repositioning the door between the open position and the closed position; and
an adjustment assembly including:
a first component including an engagement feature along a first face of the first component; and
a second component including a plurality of cutouts along a second face of the second component and including at least a first cutout defining a first depth and a second cutout defining a second depth shallower than the first depth, the first cutout and the second cutout each configured to receive the engagement feature of the first component,
wherein the first component is movable relative to the second component between a first position and a second position,
wherein, in the first position, the engagement feature of the first component is engaged with the first cutout such that the latch is laterally spaced from the bath by a first distance, and
wherein, in the second position, the engagement feature of the first component is engaged with the second cutout such that the latch is laterally spaced from the bath by a second distance greater than the first distance.

2. The locking assembly of claim 1, wherein the engagement feature is a first engagement feature of a plurality of engagement features extending from the first component, wherein the plurality of cutouts includes a first group of cutouts including the first cutout, and wherein the plurality of cutouts includes a second group of cutouts including the second cutout.

3. The locking assembly of claim 2, wherein the plurality of cutouts are radially spaced and annularly spaced apart from each other in a pattern complementary to a pattern of the plurality of engagement features.

4. The locking assembly of claim 2, wherein the first group of cutouts and the second group of cutouts each include a number of cutouts complementary to a number of the plurality of engagement features.

5. The locking assembly of claim 1, wherein the first cutout and the second cutout define a shape complementary to a shape of the engagement feature.

6. The locking assembly of claim 1, wherein, in the first position, the first face of the first component contacts the second face of the second component, and wherein, in the second position, the first face of the first component is laterally spaced from the second face of the second component.

7. The locking assembly of claim 1, wherein the first component includes a first aperture and the second component includes a second aperture, wherein the first aperture and the first aperture are configured to cooperatively receive a fastener to (i) couple the adjustment assembly to the bath and (ii) selectively retain the first component in the first position or the second position.

8. The locking assembly of claim 7, wherein the first aperture is structured to enable rotation of the first component relative to the second component between the first position and the second position while the fastener (i) couples the first component to the second component and (ii) remains received within the first aperture and the second aperture.

9. The locking assembly of claim 1, wherein the latch defines a cavity, and wherein the adjustment assembly is at least partially disposed within the cavity.

10. The locking assembly of claim 9, wherein the latch is rotatable relative to the adjustment assembly, wherein the latch includes a protrusion extending at least partially within the cavity, and wherein the protrusion engages with a portion of the adjustment assembly to limit rotation of the latch.

11. The locking assembly of claim 10, wherein the second component includes a channel defined by shoulders, wherein the protrusion is received within the channel and engages with the shoulders to limit rotation of the latch.

12. The locking assembly of claim 1, wherein the latch includes a projection configured to engage with the bath when the latch is in the locked position to retain the door in the closed position.

13. The locking assembly of claim 1, wherein the latch is rotatably coupled to a wall of the one or more walls of the bath.

14. The locking assembly of claim 1, wherein the latch is rotatably coupled to the door of the bath.

15. A locking assembly for a bath including one or more walls and a door repositionable between an open position and a closed position, the locking assembly comprising:
a latch rotatably coupled to the bath and configured to rotate between (i) a locked position to retain the door in the closed position and (ii) an unlocked position to permit repositioning the door between the open position and the closed position; and
an adjustment assembly coupled between the bath and the latch, the adjustment assembly including:
a first component including a plurality of engagement features; and
a second component including a first group of cutouts and a second group of cutouts each configured to receive the plurality of engagement features, each cutout of the first group of cutouts defining a first depth and each cutout of the second group of cutouts defining a second depth shallower than the first depth,
wherein the first component is rotatable relative to the second component between a first position and a second position,
wherein, in the first position, the plurality of engagement features of the first component are engaged with the first group of cutouts such that the latch is laterally spaced from the bath by a first distance, and
wherein, in the second position, the plurality of engagement features of the first component are engaged with the second group of cutouts such that the latch is laterally spaced from the bath by a second distance greater than the first distance.

16. The locking assembly of claim 15, wherein the first component includes a first aperture and the second component includes a second aperture, wherein the first aperture and the first aperture are configured to cooperatively receive a fastener to (i) couple the adjustment assembly to the bath and (ii) selectively retain the first component in the first position or the second position.

17. The locking assembly of claim 16, wherein the first aperture is structured to enable rotation of the first component relative to the second component between the first position and the second position while the fastener (i) couples the first component to the second component and (ii) remains received within the first aperture and the second aperture.

18. The locking assembly of claim 15, wherein the latch defines a cavity, and wherein the adjustment assembly is at least partially disposed within the cavity.

19. The locking assembly of claim 18, wherein the latch is rotatable relative to the adjustment assembly, wherein the latch includes a protrusion extending at least partially within the cavity, and wherein the protrusion engages with a portion of the adjustment assembly to limit rotation of the latch.

20. A bath including:
one or more walls defining a bathing volume;
a door repositionable between an open position and a closed position to facilitate selective access to the bathing volume; and
a locking assembly including:
a latch rotatably coupled to a wall of the one or more walls or the door, the latch movable between (i) a locked position to retain the door in the closed position and (ii) an unlocked position to permit repositioning the door between the open position and the closed position; and
an adjustment assembly coupled between the bath and the latch, the adjustment assembly including:
a first component including an engagement feature; and
a second component including a plurality of cutouts including at least a first cutout defining a first depth, a second cutout defining a second depth shallower than the first depth, and a third cutout defining a third depth, the first cutout, the second cutout, and the third cutout each configured to receive the engagement feature of the first component,
wherein the first component is rotatable relative to the second component between a first position, a second position, and a third position,
wherein, in the first position, the engagement feature of the first component is engaged with the first cutout such that the latch is laterally spaced from the bath by a first distance,
wherein, in the second position, the engagement feature of the first component is engaged with the second cutout such that the latch is laterally spaced from the bath by a second distance greater than the first distance, and
wherein, in the third position, the engagement feature of the first component is engaged with the third cutout such that the latch is laterally spaced from the bath by a third distance greater than the second distance.
